(19) United States
(12) Patent Application Publication
(10) Pub. No.: US 2012/0189388 A1
(43) Pub. Date: Jul. 26, 2012

(54) FOAMED BITUMINOUS EMULSION

(75) Inventors: Tim O'Connell, Tulsa, OK (US); Ronnie Price, Sapulpa, OK (US); Stephen Fain, Broken Arrow, OK (US); Kim Orlando, Tulsa, OK (US); James J. Barnat, Tulsa, OK (US)

(73) Assignee: ROAD SCIENCE, LLC, Tulsa, OK (US)

(21) Appl. No.: 13/010,185

(22) Filed: Jan. 20, 2011

(51) Int. Cl. E01C 19/16; C08L 95/00

(52) U.S. Cl. 404/82; 106/277

(57) ABSTRACT

The invention is a foamed bituminous emulsion comprising a bituminous emulsion and vapor entrained within the bituminous emulsion, such that the foamed bituminous emulsion is a frothy mass of foam. The temperature of the foamed bituminous emulsion may be less than 100° C., less than 75° C., or less than 50° C. The vapor entrained within the bituminous emulsion may have a volume greater than 5%, 25%, or 50% by volume of the volume of the bituminous emulsion. The foamed bituminous emulsion may be combined with paving materials to produce a foamed bituminous emulsion paving mixture. A layer may by produced by forming a bituminous emulsion; foaming the bituminous emulsion to produce a foamed bituminous emulsion, where foaming the bituminous emulsion comprises causing vapor to become entrained within the bituminous emulsion; combining the foamed bituminous emulsion with paving materials to produce a paving mixture; and applying the paving mixture to an existing surface to form a new surface. The method may further comprise compacting the new surface. The paving mixture may have a temperature less than 100° C., less than 75° C., or less than 50° C. when applied to the existing surface.

### BACKGROUND OF THE INVENTION

1. Field of the Invention

The present invention relates to bituminous emulsions, and more particularly to a bituminous emulsion that is foamed with vapor to allow for easier handling and application and a method of producing the same.

2. Description of the Related Art

It is desirable to build surfaces like roads with bituminous materials. Hot bitumen is mixed with various paving materials to form hot bituminous paving mixtures, routinely referred to as hot mix. To produce these bituminous paving mixtures, vast amounts of energy are utilized. Techniques to produce bituminous paving mixtures that are less energy intensive and more environmental friendly are highly desired.

The road construction, maintenance, and rehabilitation industry has used bituminous binders for many years. The earliest bituminous binders were utilized as hot liquid binders that were mixed with paving materials like rock and sand to form bituminous paving mixtures that could be used as a surface like a road surface.

In further developments, hydrocarbon diluents were added to hot bituminous binders to form cut-back bituminous binders allowing for use of the binders at much lower temperatures due to lower viscosity. The hydrocarbon diluents would eventually evaporate leaving the bituminous binder. The negative environmental impact of hydrocarbon diluent evaporation has greatly reduced the use of cut-back bituminous binders.

Later, bituminous binders were emulsified to form aqueous bituminous oil-in-water emulsions that could be mixed with paving materials to form emulsified bituminous paving mixtures. These mixtures could be utilized at low temperatures and are routinely called cold mix. The water in the aqueous bituminous oil-in-water emulsion would eventually evaporate leaving the bituminous binder without suffering negative environmental consequences.

Subsequently, a hybrid type of mixture was created which is in between hot mix and cold mix paving materials. This hybrid utilizes a variety of technologies to create mixtures that can be placed at temperatures substantially less than hot mix. These are routinely called warm mix. Technologies include adding water or water laden products to hot bituminous materials to create foam due to the volatilization of water. These warm mix technologies require temperatures at or above 100° C. to boil water and create foam.

To ensure adequate physical properties of cold mixtures below 100° C., the bituminous oil-in-water emulsion must be carefully engineered to provide adequate coating of the paving materials, acceptable mixing and handling properties, as well as release of the water in a reasonable period of time. Managing these three competing properties proved to be challenging.

First, proper mixing of paving materials typically requires the bituminous oil-in-water emulsion to be compatible with the paving materials and remain sufficiently emulsified to thoroughly coat the paving materials. Poorly coated paving materials may lead to moisture sensitivity of the bituminous paving mixture once in service. A roadway mixture that is not susceptible to moisture will remain stable in wet conditions. Additionally, some clays, when in the presence of water, swell excessively. Completely coating these clay particles reduces or eliminates the propensity to swell. Finally, water migrating through a mixture may cause moisture problems over time. Better coated aggregate particles will minimize the ability of moisture to travel through a mixture and can be seen in lower dielectric constants of the mixture.

An emulsification chemistry that is very stable or slower setting may be required to endure the shear imparted by mixing as well as accommodating the surface charge of the paving materials. The emulsified paving mixture also requires a sufficient amount of fluidity. A lack of fluidity may create lumps or balls of bitumen during mixing causing insufficient coating. Water may be added to increase the fluidity, allowing the emulsified bituminous paving mixture to better coat the paving materials.

Further, as paving material particles become smaller, specific surface area increases and the ability of the bituminous oil-in-water emulsion to coat these particles may become more difficult. Paving materials with extremely high specific surface area like clays may be exceptionally difficult to coat. Paving materials that have incompatibilities with the emulsification chemistry or bituminous binder may create additional coating challenges. Additionally, clays may absorb vast amounts of water and swell. This swelling may damage roadways due to heaving or other types of distresses.

Second, it is desirable for the emulsified bituminous paving mixture to maintain sufficient fluidity to be properly handled and applied to a surface like a road surface. If sufficient fluidity is not maintained, the mixture may not be properly placed. Increasing the water content in the bituminous oil-in-water emulsion paving mixture is a common practice to maintain sufficient fluidity. Additionally, the bituminous oil-in-water emulsion paving mixture should maintain sufficient fluidity to allow for post placement compaction typically performed by a compaction device, for example but not limited to a steel wheel roller, sheep's foot roller, a pad roller, or a rubber tire roller. This post placement compaction may be desired to meet critical civil engineering parameters, most notably air voids content of the compacted mixture.

Third, it is desirable for the bituminous oil-in-water emulsion paving mixture to develop sufficient structural integrity in an acceptable amount of time. The bituminous oil-in-water emulsion paving mixture may be structurally weak when initially placed due to the emulsified bitumen and independent nature of the dispersed bituminous phase. During bitumen coalescence, the mixture becomes stronger and most, if not all, of the water eventually leaves the system. This early structural weakness may allow for adequate placement and compaction. Thereafter, it is desirable for the water in the system to evaporate as quickly as possible, allowing the independent bituminous particles to coalesce, returning the original bituminous theological properties, and allowing the mixture to obtain sufficient structural integrity in an acceptable amount of time. To facilitate a quick return of the bituminous paving mixture to a sufficient structural integrity, faster setting chemicals that allow the bituminous emulsion to coalesce quickly and release water from the mixture may be selected. Additionally, less water utilized in the mixing operation may reduce the time for the mixture to achieve sufficient structural integrity.

These desirable but competing performance attributes illustrate some of the complexities of using bituminous oil-in-water emulsion paving mixtures. To promote coating of the paving materials in the mixture, slower setting chemicals may help this process. Unfortunately, these slower setting chemicals may also aid in the retention of water, may increase the time for the independent bituminous particles to coalesce, and may greatly increase the time for the mixture to reach sufficient structural integrity. Hence, slower setting chemicals may help coating but may also lengthen to time required to achieve adequate structural integrity. Current art maintains that a compromise must be struck between coating and the time it takes to reach sufficient structural integrity.

Additionally, adding water to the bituminous emulsion mixture may aid coating of the paving materials and may help maintain sufficient fluidity for placement, it may also increase the time for the water to evaporate, ultimately prolonging the bituminous paving mixture's ascent to sufficient structural integrity. Since the time to sufficient structural integrity may be days, weeks, or a month or more, the mixture may be damaged by traffic before it reaches sufficient structural integrity. Also, excessive water in the system may interfere with mixture compaction due to hydraulic packing. The compacted density of the emulsified bituminous paving mixture cannot be further densified because water is filling substantially all void spaces. As the water eventually evaporates, air voids in the bituminous emulsion paving mixture form and may be excessively high. Post placement consolidation due to traffic may collapse these excessive air voids and deform the bituminous emulsion pavement mixture. Current art maintains that a compromise must be struck between sufficient fluidity for placement and the time it takes to reach sufficient structural integrity.

Similarly, to enhance mixture fluidity, slower setting chemicals and/or additional water may be used. As mentioned above, this causes water egress to slow and may compromise compacted density, possibly leading to early failure of the mixture. To aid in the quick release of water, a quicker setting emulsifier and less water may be used. These changes may lead to poor handling and placement, less than acceptable paving materials coating, poor compacted density, and possible negative impacts on structural integrity.

Although paving mixtures with bituminous oil-in-water emulsions can be performed, this list of compromises as well as others lead to limited use due to a narrow operating window for success.

It is desirable for a bituminous emulsion to coat paving materials adequately without compromising mixture fluidity or delaying the time required to achieve sufficient structural integrity.

It is also desirable for a bituminous emulsion to coat paving materials adequately without the need for excess water in the system.

It is also desirable for a bituminous emulsion to coat paving materials adequately to reduce moisture sensitivity of the resulting mixture.

It is also desirable for a bituminous emulsion to coat paving materials adequately to maintain structural stability and reduce the swelling propensity of aggregate particles.

It is also desirable for a bituminous emulsion to coat paving materials to have low dielectric constants of the bituminous emulsion mixture.

It is also desirable for a bituminous emulsion to endure mixing shear.

It is also desirable for a bituminous emulsion to maintain sufficient fluidity for handling, lay down, and compaction.

It is also desirable for a bituminous emulsion to coat a paving materials adequately, maintain sufficient fluidity, and provide sufficient structural stability in an adequate amount of time.

It is also desirable for a bituminous emulsion to minimize both energy consumption as well as negative environmental impact.

### SUMMARY OF THE INVENTION

The invention is a foamed bituminous emulsion comprising a bituminous emulsion and vapor entrained within the bituminous emulsion, such that the foamed bituminous emulsion is a frothy mass of foam. The temperature of the foamed bituminous emulsion may be less than 100° C., less than 75° C., or less than 50° C. The bituminous emulsion may have a volume and the vapor entrained within the bituminous emulsion may have a volume greater than 5%, 25%, or 50% by volume of the volume of the bituminous emulsion.

A foamed bituminous emulsion paving mixture may comprise a bituminous emulsion, vapor entrained within the bituminous emulsion, and paving materials. The paving materials may comprise rock, crushed rock, gravel, sand, silt, clay, organic, reclaimed materials, or any combination of rock, crushed rock, gravel, sand, silt, clay, organic, and reclaimed materials. The foamed bituminous paving mixture may further comprise a surface to which the foamed bituminous emulsion paving mixture has been applied, where the foamed bituminous emulsion paving mixture may have a temperature of less than 100° C., less than 75° C. or less than 50° C. when applied to the surface.

A method of producing a foamed bituminous emulsion may comprise forming a bituminous emulsion and foaming the bituminous emulsion, where foaming the bituminous emulsion comprises causing vapor to become entrained within the bituminous emulsion. The vapor may be entrained within the bituminous emulsion through the use of a foam generating nozzle, eductor, shearing device, kinetic mixer, static mixer, hydro-dynamic device, vacuum system, or vapor creating liquids, or by chemical reaction. The vapor entrained within the bituminous emulsion forms bubbles in the foamed bituminous emulsion, and the method may further comprise adjusting the size and distribution of bubbles to suit an intended use of the foamed bituminous emulsion. The foamed bituminous emulsion may have a temperature less than 100° C., less than 75° C., or less than 50° C. The bituminous emulsion may have a volume and the vapor entrained within the bituminous emulsion may have a volume greater than 5%, 25%, or 50% by volume of the volume of the bituminous emulsion.

A method of producing a layer may comprise forming a bituminous emulsion; foaming the bituminous emulsion to produce a foamed bituminous emulsion, where foaming the bituminous emulsion comprises causing vapor to become entrained within the bituminous emulsion; combining the foamed bituminous emulsion with paving materials to produce a paving mixture; and applying the paving mixture to an existing surface to form a new surface. The method may further comprise compacting the new surface. Vapor may be entrained within the bituminous emulsion through the use of a foam generating nozzle, eductor, shearing device, kinetic mixer, static mixer, hydro-dynamic device, vacuum system, or vapor creating liquids, or by chemical reaction. The vapor entrained within the bituminous emulsion may form bubbles in the foamed bituminous emulsion, and the method may further comprise adjusting the size and distribution of bubbles to suit an intended use of the foamed bituminous emulsion prior to combining the foamed bituminous emulsion with paving materials. The foamed bituminous emulsion may have a temperature that is less than 100° C., less than 75° C., or less than 50° C. The bituminous emulsion may have a volume and the vapor entrained within the bituminous emulsion may have a volume greater than 5%, 25%, or 50% by volume of the volume of the bituminous emulsion. The paving material may have a temperature less than 100° C., less than 75° C., or less than 50° C. during the step of applying the paving mixture to the existing surface. The paving materials may comprise rock, crushed rock, gravel, sand, silt, clay, organic, reclaimed materials, or any combination or rock, crushed rock, gravel, sand, silt, clay, organic, and reclaimed materials.

### DETAILED DESCRIPTION OF THE INVENTION

The present invention relates to modifying an existing bituminous emulsion by foaming the bituminous emulsion with a vapor, enabling the foamed emulsion to coat a wide variety of materials while maintaining sufficient fluidity to mix, handle, sufficiently coat, and apply to a surface. The foamed bituminous emulsion uses a minimal amount of additional water, which allows for quick loss of water and return to sufficient structural integrity in a suitable amount of time.

The performance of an emulsified bituminous binder can be greatly enhanced if the bituminous emulsion is transitioned into a foamed state with a vapor. The vapor foamed bituminous emulsion surprisingly coats paving materials quicker and to a higher degree than conventional bituminous emulsions. Additionally, less water may be required, which may lead to improvements in water egress and the amount of time for the vapor foamed bituminous emulsion paving mixture to reach sufficient structural integrity:

Vapor foamed bituminous emulsion is a material with vapor sufficiently entrained within the emulsion, creating a frothy mass of foam. The entrained vapor may greatly increase the volume of the bituminous emulsion, and this extra volume may aid in mixing. This extra volume may also allow for sufficient coating of the particles with less bituminous emulsion. Additionally, the vapor foamed emulsion may provide greater lubricity that may enhance handling and or compaction.

Foamed bituminous emulsion may be advantageous at greater than 5% vapor entrained in the bituminous emulsion, preferably at greater than 25% vapor entrained in the bituminous emulsion, most preferably greater than 50% vapor entrained in the bituminous emulsion. All percentages are the volume of the entrained vapor at standard temperature and pressure divided by the volume of the bituminous emulsion times 100. As an example, if 50 ml of air is entrained in 100 ml of bituminous emulsion, the % vapor entrained is:

$$\begin{matrix}\% vapor entrained = ( 50 ml vapor \text{/} 100 ml bituminous emulsion ) \times \\ 100 \\ = 50 \% vapor entrained based on the volume \\ of the bituminous emulsion\end{matrix}$$

The size of the entrained vapor may be small or large or a combination of both. The persistence of the entrained vapor may be short term, long term, or a combination of both. The size, distribution, and quantity of the entrained vapor may enable adjustment of the foamed bituminous emulsion to enhance mixing, coating, handling, and or compaction. Additionally, extremely persistent foamed emulsion may also aid in the post placement compaction process. The mechanical action of the compaction process may also aid in the release of the entrained vapor from the foamed emulsion due to rupture and or coalescence of the entrained vapor.

The temperature of the bituminous emulsion foam may be at temperatures less than about 100° C., preferably less than about 75° C., and most preferably less than about 50° C. The bituminous emulsion may be, but is not limited to being classified as substantially oil-in water, substantially water-in oil, substantially multi-phased emulsion, or any combinations of two or all three.

The temperature of the foamed bituminous emulsion mixture may be applied to a surface when the foamed bituminous emulsion mixture's temperature is less than about 100° C., preferably less than about 75° C., and most preferably less than about 50° C.

The creation of foam can be achieved in many ways, including but not limited to creation of foam through the use of foam generating nozzles, eductors, shearing devices, kinetic and static mixers, hydro-dynamic devices, vacuum systems, chemical reaction, vapor creating liquids, and the like. It is anticipated a delayed chemical reaction can foam the bituminous emulsion post mixing with the paving materials. This phenomenon is intended to be included within the scope of the invention.

Foam properties may be enhanced by the inclusion of additional chemicals. These chemicals may stabilize or destabilize the foam. Additionally, these chemicals may increase or decrease the size, distribution, and quantity of foam bubbles. These additional chemicals may be added to the system in many ways such as but not limited to: during processing of the bituminous emulsion; added to the bituminous emulsion post manufacture; added to the vapor that is added to the bituminous emulsion.

The paving materials may include but are not limited to rock, crushed rock, gravel, sand, silt, clay, organic, and reclaimed materials and the like, essentially any paving material that is or may be used on roadway sub layers, base layers, inter-layers, roadways, and surfaces. Reclaimed materials may include but are not limited to crushed ceramics like glass or porcelain, crushed concrete, by-products, reclaimed asphalt pavement (RAP). recycled asphalt shingles (RAS), and the like. Paving materials may also include soils. Soils may include but are not limited to organic soils, surface soils, and parent rock. These soils may be from the twelve orders of soil classification like but are not limited to Entisols, Vertisols, Inceptisols, Aridisols, Mollisols, Spodosols, Alfisols, Utisols, Oxisols, Histosol, Andisols and Gelisols and the like. Paving materials may be of the type of soil solutions where the paving materials contain or could contain in the future other molecules or ions like but not limited to dissolved sugars, sulfates, nitrates, ammonium, potassium, phosphates, calcium, zinc, copper, and lignin.

Foamed bituminous emulsion when mixed with paving materials can be applied to any surface where the foamed bituminous emulsion mixture may be utilized as a layer. These layers may be but not limited to sub-layers, base layers, inter-layers, or surface layers.

Chemicals can be but are not limited to surfactant like emulsifiers and detergents. Emulsifiers and detergents may contain any electrical charge including no electrical charge and combinations thereof. Emulsifier and detergent types may include but are not limited to anionic, nonionic, cationic, and amphoteric chemicals as well as combinations thereof. Chemicals may be polymers or solid particles. Additionally, it is envisioned that any combination of these chemicals may be desirable.

### Example #1

A bituminous oil-in-water emulsion was produced using a PG 58-28 asphalt binder from Suncor. An aqueous solution was produced with Indulin JAK from Mead Westvaco at a concentration of 3.00% by weight of the finished emulsion. Hydrochloric acid was used to adjust the aqueous solution to about pH 2.0. The asphalt was heated to 135° C. and the aqueous solution was heated to 35° C. The asphalt was emulsified to form the bituminous oil-in-water emulsion with a 66.3% residue.

In all examples, a shearing device was used to produce the foamed bituminous emulsion. An IKA Magic Lab mill utilized to incorporate the vapor into the bituminous emulsion. The mill was rotated at about 10,000 RPM's while the asphalt emulsion at about 50° C. was fed to the lab mill at about 100 ml/min. Additionally, about 100 ml/min of compressed vapor was added to the inlet of the IKA Magic lab mill. The vapor was compressed air that has been dewatered and filtered. The calculated vapor entrainment was about 100% vapor based on the volume of the bituminous emulsion. The vapor foamed bituminous emulsion was collected for use and was not held for more than 5 minutes before mixing with paving materials.

The emulsified bituminous binder of the first example was mixed with paving materials which consisted of limestone aggregate. The limestone aggregate was graded as follows:

| Sieve Size | % Passing |
|---|---|
| 37.5 mm | 100 |
| 25.0 mm | 88 |
| 19.0 mm | 66 |
| 12.5 mm | 53 |
| 9.5 mm | 43 |
| 4.75 mm | 31 |
| 2.36 mm | 25 |
| 1.18 mm | 21 |
| 600 μm | 18 |
| 300 μm | 15 |
| 150 μm | 12 |
| 75 μm | 10.4 |

Additionally, a Sand Equivalence Test was performed on the limestone aggregate per ASTM D2419 with a result of 24 and a Methylene Blue test was performed per AASHTO T330 with a result of 15.

The limestone aggregate was prepared and mixed with 3.3% water for about 60 seconds. The pre-wet mixture was sealed in a plastic container for about 24 hours. The pre-wet aggregate was mixed with 5% bituminous emulsion for about 60 seconds. The same bituminous emulsion was foamed as defined above to create the foamed bituminous emulsion. Five percent of the foamed bituminous emulsion was mixed with the pre-wet aggregate for about 60 seconds. All paving mixture percentages are calculated as the weight of the emulsion based on the weight of the dry aggregate. The mixtures were placed into 40° C. oven for 30 minutes then compacted on a Superpave Gyratory Compactor following AASHTO T312 sections 1-7 and 9. The compaction molds were not heated. The mixtures were compacted for 30 gyrations and then extracted immediately. The compacted specimens were cured for 72 hours at 40° C. in an oven then further cured at room temperature for another 24 hours. The mixtures were tested for Indirect Tensile Strength (ITS) following ASTM D4867 named ‘Standard Test Method for Effect of Moisture on Asphalt Concrete Paving Mixtures’ following sections 8.1 through 8.5 and section 8.11. The specimens were tested dry (Dry Strength) and another set of specimens were conditioned in water (Conditioned Sample) for 24 hours at 25° C. then tested. All samples were tested in duplicate and are reported in Table #1.

TABLE #1
Indirect Tensile Strength Testing Data

| | |
|---|---|
| Bituminous Emulsion | Foamed Bituminous Emulsion |

| Conditioned | Dry | Conditioned | Dry |
|---|---|---|---|
| Sample | Sample | Sample | Sample |
| Strength | Strength | Strength | Strength |
| (psi) | (psi) | (psi) | (psi) |
| 24.2 | 51.5 | 29.7 | 51.7 |
| 20.6 | 46.5 | 34.1 | 55.3 |

The IDT tests the moisture sensitivity of a mixture. Retained strength is desired and the higher the retained strength the better. Table #2 details the comparative results from the data set in Table #1.

TABLE #2
Calculated Results
Foamed Bituminous Emulsion Performance

| | |
|---|---|
| Dry Strength Increase | 9.2% |
| Wet Strength Increase | 42.4% |
| Retained Strength Increase | 30.4% |

Surprisingly, the foamed Bituminous Emulsion mixture provided additional dry strength, higher wet strength, and significantly improved retained strength even though the same bituminous content was utilized for all samples. This foamed bituminous emulsion mixture may be used as but not limited to a surface layer or an interlayer of a road.

### Example #2

The paving materials of example #1 was similarly mixed with 3.3% water and stored for about 24 hours at room temperature. The pre-wet paving materials were mixed with 5% of the bituminous emulsion as well as the foamed bituminous emulsion of example #1. After mixing, these bituminous mixtures were held at 60° C. for 30 minutes. The mixtures were then compacted per Texas Department of Transportation (TxDOT) Test Method Tex-113-E. The specimens were extracted immediately and were cured at 60° C. for about 48 hours and further cured at room temperature for about 24 hours. The samples were moisture conditioned per TxDOT Tex-144-E procedures maintaining 10 days of conditioning.

The specimens were tested for Unconfined Compressive Strength (UCS) per TxDOT Test Method Tex-117-E Section 5.18 titled ‘Triaxial Compression for Disturbed Soils and Base Materials’. The averages of duplicate tests for the wet strengths are shown in Table #3.

TABLE #3
UCS Data
Unconfined Compressive Strength Data

| | (psi) |
|---|---|
| Bituminous Emulsion | 91.1 |
| Foamed Bituminous Emulsion | 149.6 |

The Foamed Bituminous Emulsion mixture unexpectedly performed 59% better in wet strength testing with an increase in strength versus conventional bituminous emulsion. This increase in wet strength suggests this mixture will be less susceptible to the harmful effects of water in the environment leading to a superior pavement. This foamed bituminous emulsion mixture may be used as but not limited to an interlayer or a surface layer of a road.

### Example #3

Paving materials were used that consisted of 50% by weight of the limestone aggregate from example #1 and 50% of a coarse sand. The coarse sand was classified as per ASTM D2487 titled ‘Standard Practice for Classification of Soils For Engineering Purposes (Unified Soil Classification System)’ abbreviated as ‘USCS’. This aggregate classified as a ‘Silty Sand with Gravel’. A Plasticity index (PI) was conducted as per ASTM D4318 titled ‘Standard Test Methods for Liquid Limit, Plastic Limit, and Plasticity Index of Soils’ and yielded a result of 2. The gradation of the Coarse Sand is shown below.

| Sieve Size | | % Passing |
|---|---|---|
| 37.5 | mm | 100 |
| 25 | mm | 100 |
| 19 | mm | 98.5 |
| 9.5 | mm | 87.0 |
| 4.75 | mm | 77.0 |
| 2 | mm | 68.4 |
| 850 | μm | 58.4 |
| 425 | μm | 44.3 |
| 250 | μm | 28.6 |
| 180 | μm | 20.5 |
| 106 | μm | 14.5 |
| 75 | μm | 12.0 |

The blended paving materials were mixed with 3.1% water and stored similar to example #1. Next, the bituminous emulsion and foamed bituminous emulsion were mixed at 5.5% each based on the weight of the dry aggregate, were stored and cured similarly to example #1. The bituminous mixtures were compacted similar to example #1. Samples were produced for IDT testing and moisture conditioning was also similar to example #1. The test results are shown in Table #4:

TABLE #4
Indirect Tensile Strength Testing Data

Bituminous Emulsion

| | | |
|---|---|---|
| Conditioned | Dry | Foamed Bituminous Emulsion |

| Sample | Sample | Conditioned Sample | Dry Sample |
|---|---|---|---|
| Strength | Strength | Strength | Strength |
| (psi) | (psi) | (psi) | (psi) |
| 40.0 | 71.1 | 44.1 | 75.3 |
| 36.1 | 69.6 | 45.6 | 78.8 |

The Foamed Bituminous Emulsion mixture performed better than the Bituminous Emulsion in Dry and Wet strength testing as well as the calculated Retained Strength as seen in Table #5:

TABLE #5
Calculated Results
Foamed Bituminous Emulsion Performance

| | |
|---|---|
| Dry Strength Increase | 9.5% |
| Wet Strength Increase | 17.9% |
| Retained Strength Increase | 7.6% |

This foamed bituminous emulsion mixture may be used but not limited to as a base layer, an interlayer, or a sub layer of a road.

### Example #4

Another paving material was produced which utilized 50% of the Coarse Sand from example 3 and 50% of a Clay. The Clay was USCS classified as a ‘Lean Clay’, had a PI of 16, and a gradation as shown below:

| Sieve Size | | % Passing |
|---|---|---|
| 37.5 | mm | 100 |
| 25 | mm | 100 |
| 19 | mm | 100 |
| 9.5 | mm | 100 |
| 4.75 | mm | 100 |
| 2 | mm | 99.7 |
| 850 | μm | 98.8 |
| 425 | μm | 97.7 |
| 250 | μm | 96.9 |
| 180 | μm | 96.3 |
| 106 | μm | 95.2 |
| 75 | μm | 93.9 |

The aggregate blend was mixed with 9% water and was sealed and stored similarly to example #1. The pre-wet aggregate was mixed with both 5% and 6.5% bituminous emulsion and foamed bituminous emulsion. The mixtures were stored for 30 minutes at 40° C. similar to example #1. The mixtures were also compacted, stored at 40° C. and at room temperature similar to example #1.

A Tube Suction Test was performed for the determination of dielectric constant, which is a unitless number. The test was performed per TxDOT Tex-144-E sections 13 through 15. The data is shown in Table #5:

TABLE #5
Dielectric Constant Data
Dielectric Constant

| | |
|---|---|
| 5% emulsion added | 6.5% Emulsion added |

| Bituminous | Foamed | Bituminous | Foamed |
|---|---|---|---|
| Emulsion | Emulsion | Emulsion | Emulsion |
| 26.9 | 23.8 | 19.6 | 7.4 |
| 27.9 | 12.2 | 27.1 | 7.4 |

The data shows the foamed bituminous emulsion mixture outperforms the regular bituminous emulsion at both levels indicating the foamed stabilized aggregate is better waterproofed. This demonstrates that less water can travel through the foamed bituminous mixtures. This foamed bituminous emulsion mixture may be used but not limited to as a base layer, an interlayer, or a sub layer of a road.

A Swell Test was also performed on these two mixtures to determine how the bituminous materials affected the natural ability of clay to absorb water and swell. The samples were placed onto porous stones that were submerged in water for 10 days. The samples were wrapped in latex sleeves to minimize any moisture loss from the sides. The diameters of the samples were measured at three separate heights and the overall height was measured. The diameters were averaged and the volume of the sample was calculated before and after the moisture conditioning. The results are shown in Table #6:

TABLE #6
Swell Test Data
Swell Test

| | |
|---|---|
| 5% emulsion added | 6.5% Emulsion added |

| Bituminous | Foamed | Bituminous | Foamed |
|---|---|---|---|
| Emulsion | Emulsion | Emulsion | Emulsion |
| 6.2 | 5.2 | 4.6 | 1.6 |
| 7.0 | 4.7 | 5.7 | 2.4 |

The data shows the increased performance of the foamed bituminous emulsion. The addition of 6.5% of the traditional bituminous emulsion does not impact the swelling nature of the aggregate system as well as 5% of the foamed bituminous emulsion. Overall, the 5% and 6.5% foamed bituminous emulsion reduced the swelling of the aggregate mixture surprisingly by 25% and 61% respectively as seen in Table #7.

TABLE #7
Calculated Results
Reduced Swelling from Foamed Emulsion

| | |
|---|---|
| 5.0% Bituminous Emulsion | −25.0% |
| 6.5% Bituminous Emulsion | −61.2% |

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed. In particular, the foregoing foamed bituminous emulsion and method of use may be used with any binder and for any layer.

What is claimed is:

1. A foamed bituminous emulsion comprising:
a bituminous emulsion; and
vapor entrained within the bituminous emulsion;
such that the foamed bituminous emulsion is a frothy mass of foam.

2. The foamed bituminous emulsion of claim 1 where the temperature of the foamed bituminous emulsion is less than 100° C.

3. The foamed bituminous emulsion of claim 1 where the temperature of the foamed bituminous emulsion is less than 75° C.

4. The foamed bituminous emulsion of claim 1 where the temperature of the foamed bituminous emulsion is less than 50° C.

5. The foamed bituminous emulsion of claim 1 where the bituminous emulsion has a volume and the vapor entrained within the bituminous emulsion has a volume greater than 5% by volume of the volume of the bituminous emulsion.

6. The foamed bituminous emulsion of claim 1 where the bituminous emulsion has a volume and the vapor entrained within the bituminous emulsion has a volume greater than 25% by volume of the volume of the bituminous emulsion.

7. The foamed bituminous emulsion of claim 1 where the bituminous emulsion has a volume and the vapor entrained within the bituminous emulsion has a volume greater than 50% by volume of the volume of the bituminous emulsion.

8. A foamed bituminous emulsion paving mixture comprising:
a bituminous emulsion;
vapor entrained within the bituminous emulsion; and
paving materials.

9. The foamed bituminous emulsion paving mixture of claim 8 where the paving materials comprise rock, crushed rock, gravel, sand, silt, clay, organic, reclaimed materials, or any combination of rock, crushed rock, gravel, sand, silt, clay, organic, and reclaimed materials.

10. The foamed bituminous paving mixture of claim 8 further comprising a surface to which the foamed bituminous emulsion paving mixture has been applied, where the foamed bituminous emulsion paving mixture has a temperature of less than 100° C. when applied.

11. The foamed bituminous paving mixture of claim 10 where the application of the foamed bituminous emulsion paving mixture has a temperature of less than 75° C. when applied.

12. The foamed bituminous paving mixture of claim 10 where the application of the foamed bituminous emulsion paving mixture has a temperature of less than 50° C. when applied.

13. A method of producing a foamed bituminous emulsion, the method comprising:
forming a bituminous emulsion; and
foaming the bituminous emulsion, where foaming the bituminous emulsion comprises causing vapor to become entrained within the bituminous emulsion.

14. The method of claim 13 where vapor is entrained within the bituminous emulsion through the use of a foam generating nozzle, eductor, shearing device, kinetic mixer, static mixer, hydro-dynamic device, vacuum system, or vapor creating liquids, or by chemical reaction.

15. The method of claim 13 where the vapor entrained within the bituminous emulsion forms bubbles in the foamed bituminous emulsion, and where the method further comprises adjusting the size and distribution of bubbles to suit an intended use of the foamed bituminous emulsion.

16. The method of claim 13 where the foamed bituminous emulsion has a temperature less than 100° C.

17. The method of claim 13 where the foamed bituminous emulsion has a temperature less than 75° C.

18. The method of claim 13 where the foamed bituminous emulsion has a temperature less than 50° C.

19. The method of claim 13 where the bituminous emulsion has a volume and where the vapor entrained within the bituminous emulsion has a volume greater than 5% by volume of the volume of the bituminous emulsion.

20. The method of claim 13 where the bituminous emulsion has a volume and where the vapor entrained within the bituminous emulsion has a volume greater than 25% by volume of the volume of the bituminous emulsion.

21. The method of claim 13 where the bituminous emulsion has a volume and where the vapor entrained within the bituminous emulsion has a volume greater than 50% by volume of the volume of the bituminous emulsion.

22. A method of producing a layer, the method comprising:
forming a bituminous emulsion;
foaming the bituminous emulsion to produce a foamed bituminous emulsion, where foaming the bituminous emulsion comprises causing vapor to become entrained within the bituminous emulsion;
combining the foamed bituminous emulsion with paving materials to produce a paving mixture; and
applying the paving mixture to an existing surface to form a new surface.

23. The method of claim 22 further comprising compacting the new surface.

24. The method of claim 22 where vapor is entrained within the bituminous emulsion through the use of a loam generating nozzle, eductor, shearing device, kinetic mixer, static mixer, hydro-dynamic device, vacuum system, or vapor creating liquids, or by chemical reaction.

25. The method of claim 22 where the vapor entrained within the bituminous emulsion forms bubbles in the foamed bituminous emulsion, and where the method further comprises adjusting the size and distribution of bubbles to suit an intended use of the foamed bituminous emulsion prior to combining the foamed bituminous emulsion with paving materials.

26. The method of claim 22 where the foamed bituminous emulsion has a temperature that is less than 100° C.

27. The method of claim 22 where the foamed bituminous emulsion has a temperature that is less than 75° C.

28. The method of claim 22 where the foamed bituminous emulsion has a temperature that is less than 50° C.

29. The method of claim 22 where the bituminous emulsion has a volume and where the vapor entrained within the bituminous emulsion has a volume greater than 5% by volume of the volume of the bituminous emulsion.

30. The method of claim 22 where the bituminous emulsion has a volume and where the vapor entrained within the bituminous emulsion has a volume greater than 25% by volume of the volume of the bituminous emulsion.

31. The method of claim 22 where the bituminous emulsion has a volume and where the vapor entrained within the bituminous emulsion has a volume greater than 50% by volume of the volume of the bituminous emulsion.

32. The method of claim 22 where the paving mixture has a temperature of less than 100° C. during the step of applying the paving mixture to the existing surface.

33. The method of claim 22 where the paving mixture has a temperature of less than 75° C. during the step of applying the paving mixture to the existing surface.

34. The method of claim 22 where the paving mixture has a temperature of less than 50° C. during the step of applying the paving mixture to the existing surface.

35. The method of claim 22 where the paving materials comprise rock, crushed rock, gravel, sand, silt, clay, organic reclaimed materials, or any combination of rock, crushed rock, gravel, sand, silt, clay, organic, and reclaimed materials.
